(19) United States
(12) Patent Application Publication
(10) Pub. No.: US 2026/0153186 A1
(43) Pub. Date: Jun. 4, 2026

(54) Quick Locking Mechanism for Tripod Leg Tubes

(71) Applicant: Guangdong Laitu Imaging Technology Co., Ltd., Zhongshan City (CN)

(72) Inventors: Tongling Deng, Zhongshan City (CN); Huaisheng Wang, Zhongshan City (CN)

(21) Appl. No.: 19/336,876

(22) Filed: Sep. 23, 2025

(30) Foreign Application Priority Data
Nov. 29, 2024 (CN) 2024229517867

(51) Int. Cl. F16M 11/26

(52) U.S. Cl. CPC F16M 11/26; F16M 2200/027

(57) ABSTRACT

A quick locking mechanism for tripod leg tubes comprises a first leg tube, a second leg tube, and a third leg tube sequentially fitted together. A first locking mechanism is disposed between the first and second leg tubes, and a second locking mechanism is disposed between the second and third leg tubes. A synchronization shaft extends through the first, second, and third leg tubes and is coupled to both locking mechanisms. The second leg tube is rotatably arranged relative to the first and third leg tubes, such that rotation of the second leg tube in a first direction synchronously actuates both locking mechanisms to lock, and rotation in a second direction synchronously actuates both locking mechanisms to unlock. This configuration enables rapid locking and unlocking by rotating the second leg tube alone, thereby reducing manual operations and improving efficiency.

### FIELD OF INVENTION

The present invention relates to the technical field of photographic support equipment, and more particularly to a quick locking mechanism for tripod leg tubes.

### BACKGROUND OF THE INVENTION

In conventional telescopic tripod leg tubes, each pair of adjacent leg tube segments is typically provided with a locking mechanism that enables locking and unlocking by means of a manually operated actuation knob. A significant drawback of this structure is that each leg tube segment must be individually tightened or loosened to achieve locking or unlocking. When the tripod leg incorporates three or more telescoping segments, the user is required to repeatedly actuate multiple knobs, which results in cumbersome operation. Moreover, such a structure cannot accomplish simultaneous locking or unlocking of multiple sections through the rotation of a single component. Consequently, this arrangement suffers from operational complexity, reduced efficiency, and an inability to achieve rapid locking and unlocking, thereby necessitating further improvement.

### SUMMARY OF THE INVENTION

The present invention is directed to addressing at least one of the technical problems identified in the prior art. To this end, the present invention provides a quick locking mechanism for tripod leg tubes.

According to one aspect of the invention, a quick locking mechanism for tripod leg tubes comprises a first leg tube, a second leg tube, and a third leg tube sequentially fitted together. A first locking mechanism is disposed between the first leg tube and the second leg tube, and a second locking mechanism is disposed between the second leg tube and the third leg tube. A synchronization shaft is jointly received within the first leg tube, the second leg tube, and the third leg tube, and both the first locking mechanism and the second locking mechanism are coupled to the synchronization shaft.

The second leg tube is rotatably arranged relative to the first leg tube and the third leg tube.

When the second leg tube is rotated in a first direction, the first locking mechanism and the second locking mechanism are synchronously actuated to perform a locking action.

When the second leg tube is rotated in a second direction, the first locking mechanism and the second locking mechanism are synchronously actuated to perform an unlocking action.

In one preferred embodiment, the first locking mechanism comprises a first locking sleeve fixed to a lower end of the first leg tube. A sliding sleeve is sleeved onto the synchronization shaft. The first locking sleeve is provided with a first restraining ring that engages an outer wall of the sliding sleeve. An upper end of the sliding sleeve is provided with a second restraining ring, and a first spring is sleeved around the sliding sleeve between the first restraining ring and the second restraining ring.

A rotatable linkage member is rotatably mounted on the sliding sleeve below the first restraining ring. The rotatable linkage member carries a plurality of first clamping jaws, each first clamping jaw having an inner wall surface formed as a first tapered surface. An outer wall surface of the first locking sleeve is formed as a second tapered surface, the first tapered surface being in fitted engagement with the second tapered surface. An outer wall surface of each first clamping jaw engages an inner wall of the second leg tube.

The rotatable linkage member is arranged to rotate synchronously with the second leg tube and to move upward and downward relative to the second leg tube.

An upper surface of the rotatable linkage member is formed with a plurality of first guide cam blocks arranged in a circumferential array. A lower surface of the first locking sleeve is formed with a plurality of second guide cam blocks, each first guide cam block being in fitted engagement with a corresponding second guide cam block.

In another preferred embodiment, a restraint base is fixed on the synchronization shaft below the rotatable linkage member. The restraint base is formed with a guiding track channel, and the rotatable linkage member is provided with a guiding block movably inserted into the guiding track channel.

In another preferred embodiment, an outer wall surface of each first clamping jaw is provided with a first friction lining configured to engage an inner wall of the second leg tube.

In another preferred embodiment, the sliding sleeve is provided with a longitudinal guidance slot, and the first restraining ring is provided with an alignment pin movably inserted into the longitudinal guidance slot.

In another preferred embodiment, the second locking mechanism comprises a second locking sleeve fixed to a lower end of the second leg tube. A stationary sleeve is fixed to a lower end of the synchronization shaft. The second locking sleeve is provided with a third restraining ring that engages an outer wall of the stationary sleeve. An upper end of the stationary sleeve is provided with a fourth restraining ring, and a second spring is sleeved between the third restraining ring and the fourth restraining ring.

A stationary coupling member is mounted on the stationary sleeve, the stationary coupling member being provided with a plurality of second clamping jaws. An inner wall surface of each second clamping jaw is formed as a third tapered surface. An outer wall surface of the second locking sleeve is formed as a fourth tapered surface, the third tapered surface being in fitted engagement with the fourth tapered surface. An outer wall surface of each second clamping jaw engages an inner wall of the third leg tube.

An upper surface of the stationary coupling member is formed with a plurality of third guide cam blocks arranged in a circumferential array. A lower surface of the second locking sleeve is provided with a plurality of fourth guide cam blocks, each third guide cam block being in fitted engagement with a corresponding fourth guide cam block.

The stationary coupling member is slidably arranged within the third leg tube.

In another preferred embodiment, an outer wall surface of each second clamping jaw is provided with a second friction lining configured to engage an inner wall of the third leg tube.

In another preferred embodiment, the second leg tube is fixedly provided with a rotational grip sleeve.

Compared with the prior art, the present invention allows the second leg tube to be rotatably arranged relative to the first leg tube and the third leg tube. When the second leg tube is rotated in the first direction, the first locking mechanism and the second locking mechanism are synchronously actuated to perform the locking action. When the second leg tube is rotated in the second direction, the first locking mechanism and the second locking mechanism are synchronously actuated to perform the unlocking action. Thus, the present invention enables synchronous driving of both the first locking mechanism and the second locking mechanism through rotation of the second leg tube alone, thereby reducing manual operations, improving operational efficiency, and enhancing user experience.

### BRIEF DESCRIPTION OF THE DRAWINGS

FIG. 1 is a perspective structural schematic view of the quick locking mechanism according to the present invention;

FIG. 2 is a cross-sectional structural schematic view of the quick locking mechanism;

FIG. 3 is an enlarged view of portion A in FIG. 2;

FIG. 4 is an enlarged view of portion B in FIG. 2;

FIG. 5 is another cross-sectional structural schematic view of the quick locking mechanism;

FIG. 6 is a perspective structural schematic view of the first locking mechanism and the second locking mechanism;

FIG. 7 is a structural schematic view of the first locking sleeve and the rotatable linkage member;

FIG. 8 is a structural schematic view of the second locking sleeve and the stationary coupling member;

FIG. 9 is a cross-sectional structural schematic view of the leg tube in a retracted state; and

FIG. 10 is a perspective structural schematic view of a tripod incorporating the quick locking mechanism.

### DETAILED DESCRIPTION OF THE PREFERRED EMBODIMENTS

The present invention will now be further described with reference to the accompanying drawings and illustrative embodiments.

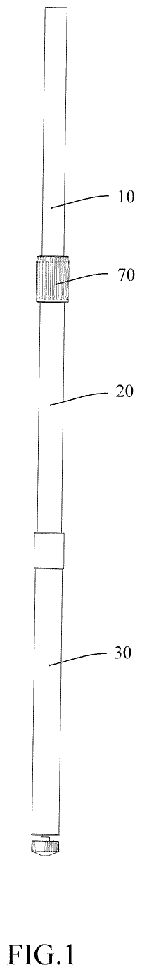

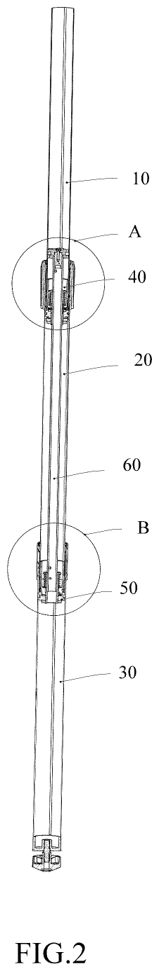

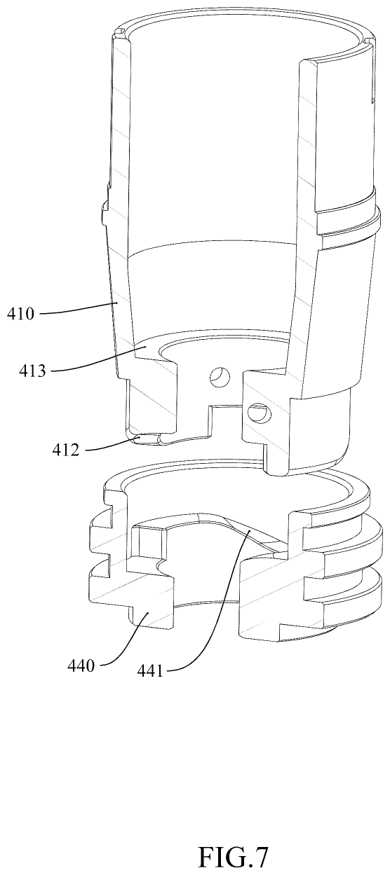

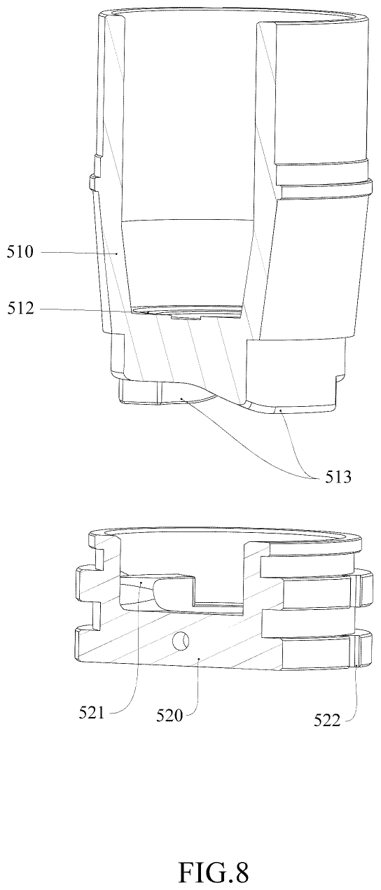

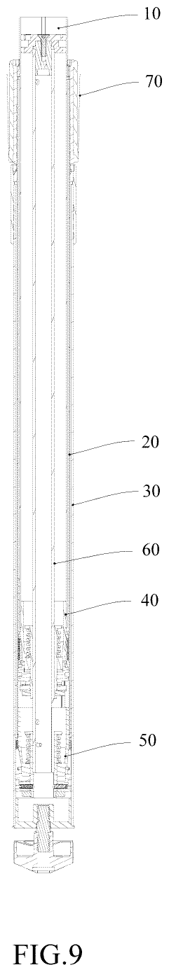

Referring to FIGS. 1 to 10, a quick locking mechanism for tripod leg tubes comprises a first leg tube 10, a second leg tube 20, and a third leg tube 30 sequentially fitted together. A first locking mechanism 40 is disposed between the first leg tube 10 and the second leg tube 20, and a second locking mechanism 50 is disposed between the second leg tube 20 and the third leg tube 30. A synchronization shaft 60 is jointly received within the first leg tube 10, the second leg tube 20, and the third leg tube 30, and both the first locking mechanism 40 and the second locking mechanism 50 are coupled to the synchronization shaft 60. The second leg tube 20 is rotatably arranged relative to the first leg tube 10 and the third leg tube 30. When the second leg tube 20 is rotated in a first direction, the first locking mechanism 40 and the second locking mechanism 50 are synchronously actuated to perform a locking action. When the second leg tube 20 is rotated in a second direction, the first locking mechanism 40 and the second locking mechanism 50 are synchronously actuated to perform an unlocking action.

Accordingly, the present invention enables synchronous actuation of the first locking mechanism 40 and the second locking mechanism 50 for locking and unlocking solely through rotation of the second leg tube 20. This configuration reduces manual operations, thereby improving operational efficiency, enhancing user convenience, and addressing user requirements for rapid deployment and retraction.

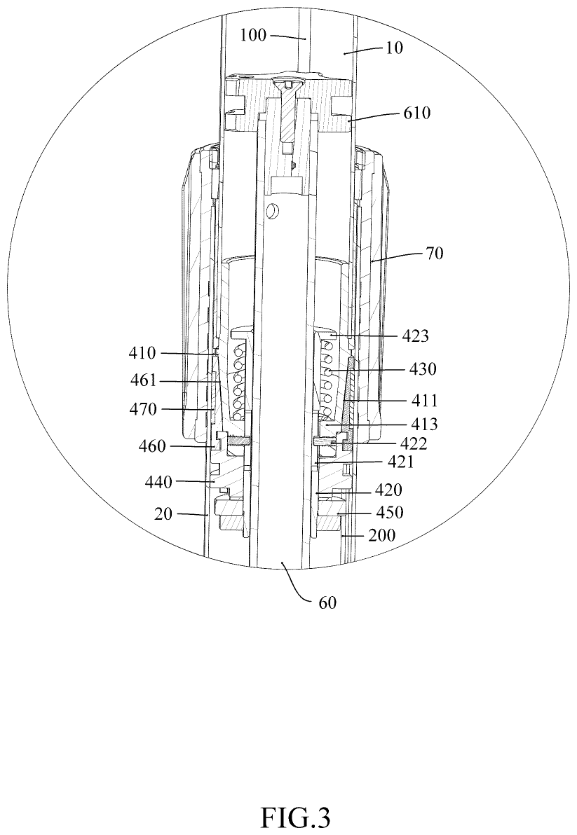

Referring to FIG. 3, the first locking mechanism 40 comprises a first locking sleeve 410 fixed to a lower end of the first leg tube 10. A sliding sleeve 420 is sleeved around the synchronization shaft 60. The first locking sleeve 410 is provided with a first restraining ring 413 that engages an outer wall of the sliding sleeve 420. An upper end of the sliding sleeve 420 is provided with a second restraining ring 423, and a first spring 430 is disposed around the sliding sleeve 420 between the first restraining ring 413 and the second restraining ring 423.

A rotatable linkage member 440 is rotatably mounted on the sliding sleeve 420 below the first restraining ring 413. The rotatable linkage member 440 carries a plurality of first clamping jaws 460. Each first clamping jaw 460 has an inner wall surface formed as a first tapered surface 461, and the first locking sleeve 410 has an outer wall surface formed as a second tapered surface 411. The first tapered surface 461 is in fitted engagement with the second tapered surface 411, while an outer wall surface of each first clamping jaw 460 engages an inner wall of the second leg tube 20.

The rotatable linkage member 440 is configured to rotate synchronously with the second leg tube 20 and to move upward and downward relative to the second leg tube 20.

An upper surface of the rotatable linkage member 440 is provided with a plurality of first guide cam blocks 441 arranged in a circumferential array, and a lower surface of the first locking sleeve 410 is provided with a plurality of second guide cam blocks 412. A lower surface of each first guide cam block 441 engages an upper surface of a corresponding second guide cam block 412.

During unlocking, the second leg tube 20 is rotated in the second direction, thereby synchronously rotating the rotatable linkage member 440. Under the cooperative action of the second guide cam blocks 412 and the first guide cam blocks 441, the rotatable linkage member 440, together with the first clamping jaws 460, moves in a direction away from the first locking sleeve 410, causing the first clamping jaws 460 to disengage from the first locking sleeve 410. Without the pressing action of the first locking sleeve 410, the second leg tube 20 is permitted to move freely upward and downward relative to the first leg tube 10, thereby achieving unlocking.

In this configuration, the first spring 430 applies an upward force to the sliding sleeve 420, thereby urging the sliding sleeve 420, the rotatable linkage member 440, and the first clamping jaws 460 upward. As a result, the first clamping jaws 460 are pressed against the first locking sleeve 410, causing the first clamping jaws 460 to tightly engage the inner wall of the second leg tube 20, thereby establishing a locked state.

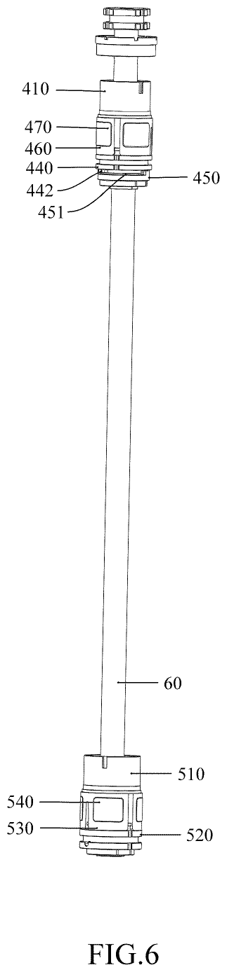

Referring to FIG. 6, a restraint base 450 is fixed on the synchronization shaft 60 below the rotatable linkage member 440. The restraint base 450 is formed with a guiding track channel 451. The rotatable linkage member 440 is provided with a guiding block 442 movably inserted into the guiding track channel 451. The cooperation of the guiding block 442 with the guiding track channel 451 constrains the rotational angle of the second leg tube 20 and the rotatable linkage member 440.

Referring to FIGS. 3 and 6, an outer wall surface of each first clamping jaw 460 is provided with a first friction lining 470 that engages an inner wall of the second leg tube 20. The first friction lining 470 enhances frictional engagement with the inner wall of the second leg tube 20, thereby improving locking stability.

Referring to FIG. 3, the sliding sleeve 420 is provided with a longitudinal guidance slot 421. The first restraining ring 413 is provided with an alignment pin 422 movably inserted into the longitudinal guidance slot 421. The cooperative engagement of the alignment pin 422 within the longitudinal guidance slot 421 enhances the stability of the sliding movement.

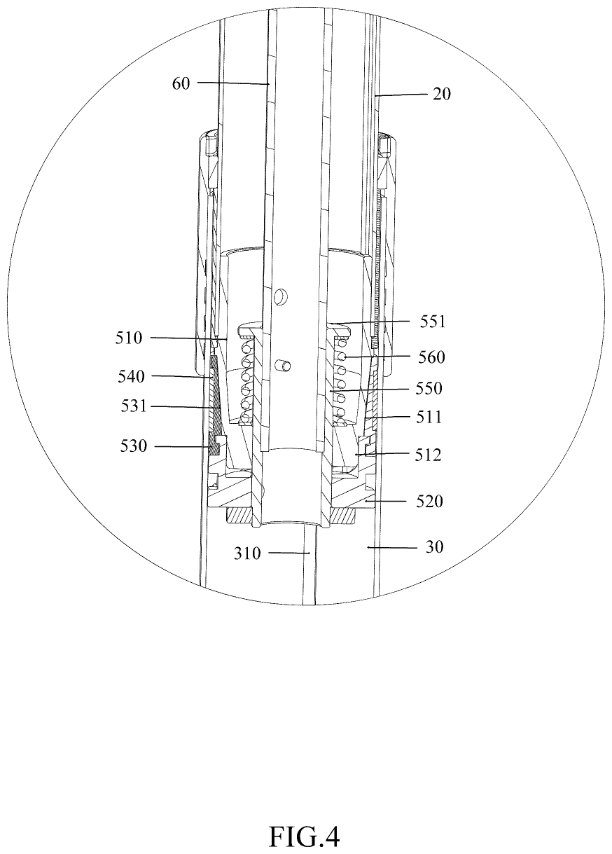

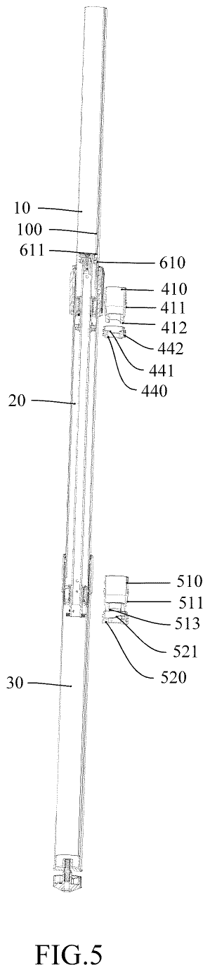

Referring to FIGS. 4 and 5, the second locking mechanism 50 comprises a second locking sleeve 510 fixed to a lower end of the second leg tube 20. A stationary sleeve 550 is mounted on a lower end of the synchronization shaft 60. The second locking sleeve 510 is provided with a third restraining ring 512 that engages an outer wall of the stationary sleeve 550. An upper end of the stationary sleeve 550 is provided with a fourth restraining ring 551, and a second spring 560 is sleeved around the stationary sleeve 550 between the third restraining ring 512 and the fourth restraining ring 551.

A stationary coupling member 520 is fixed to the stationary sleeve 550. The stationary coupling member 520 carries a plurality of second clamping jaws 530. Each second clamping jaw 530 has an inner wall surface formed as a third tapered surface 531, and the second locking sleeve 510 has an outer wall surface formed as a fourth tapered surface 511. The third tapered surface 531 is in fitted engagement with the fourth tapered surface 511, while an outer wall surface of each second clamping jaw 530 engages an inner wall of the third leg tube 30.

An upper surface of the stationary coupling member 520 is provided with a plurality of third guide cam blocks 521 arranged in a circumferential array, and a lower surface of the second locking sleeve 510 is provided with a plurality of fourth guide cam blocks 513. A lower surface of each third guide cam block 521 engages an upper surface of a corresponding fourth guide cam block 513.

The stationary coupling member 520 is slidably arranged within the third leg tube 30.

When the second leg tube 20 is rotated in the second direction, the cooperation of the third guide cam blocks 521 and the fourth guide cam blocks 513 causes the second leg tube 20 and the second locking sleeve 510 to move relative to the stationary coupling member 520. As a result, the second clamping jaws 530 disengage from the second locking sleeve 510. Without the pressing action of the second locking sleeve 510, the second clamping jaws 530 deform inwardly, allowing the third leg tube 30 to move freely upward and downward, thereby achieving unlocking.

In the present invention, the second spring 560 applies an upward force to the stationary sleeve 550, thereby urging the second clamping jaws 530 upward into pressing engagement with the second locking sleeve 510. This configuration enables the first clamping jaws 460 to be tightly pressed against the inner wall of the second leg tube 20, thereby achieving a locked state.

Referring to FIGS. 4 and 6, an outer wall surface of each second clamping jaw 530 is provided with a second friction lining 540 that engages an inner wall of the third leg tube 30. The second friction lining 540 enhances frictional engagement with the inner wall of the third leg tube 30, thereby improving locking stability.

Referring to FIG. 1, the second leg tube 20 is fixedly provided with a rotational grip sleeve 70, which facilitates gripping and manipulation of the second leg tube 20 to effect its rotation.

Referring to FIGS. 3 and 5, an outer wall surface of the rotatable linkage member 440 is provided with a first alignment keyway 442, and an inner wall surface of the second leg tube 20 is provided with a first positioning key 200. The first positioning key 200 is inserted into the first alignment keyway 442. Through this engagement, the rotatable linkage member 440 is constrained to rotate synchronously with the second leg tube 20, while remaining capable of moving upward and downward relative to the second leg tube 20.

Referring to FIG. 4, an inner wall surface of the third leg tube 30 is provided with a second positioning key 310, and an outer wall surface of the stationary coupling member 520 is provided with a second alignment keyway 522. The second positioning key 310 is inserted into the second alignment keyway 522. This arrangement constrains the stationary coupling member 520 to move only upward and downward relative to the third leg tube 30, while preventing relative rotation. Accordingly, when the second locking sleeve 510 is rotated, the cooperative engagement of the third guide cam blocks 521 and the fourth guide cam blocks 513 causes the stationary coupling member 520 to move in a direction away from the second locking sleeve 510.

Referring to FIG. 5, an upper end of the synchronization shaft 60 is provided with a guide head 610, an outer wall surface of the guide head 610 being formed with a third alignment keyway 611. The first leg tube 10 is provided with a third positioning key 100, which is movably inserted into the third alignment keyway 611. Through the cooperative engagement of the third positioning key 100 and the third alignment keyway 611, the guide head 610 and the synchronization shaft 60 are constrained to move only upward and downward relative to the first leg tube 10, while being prevented from rotation relative to the first leg tube 10.

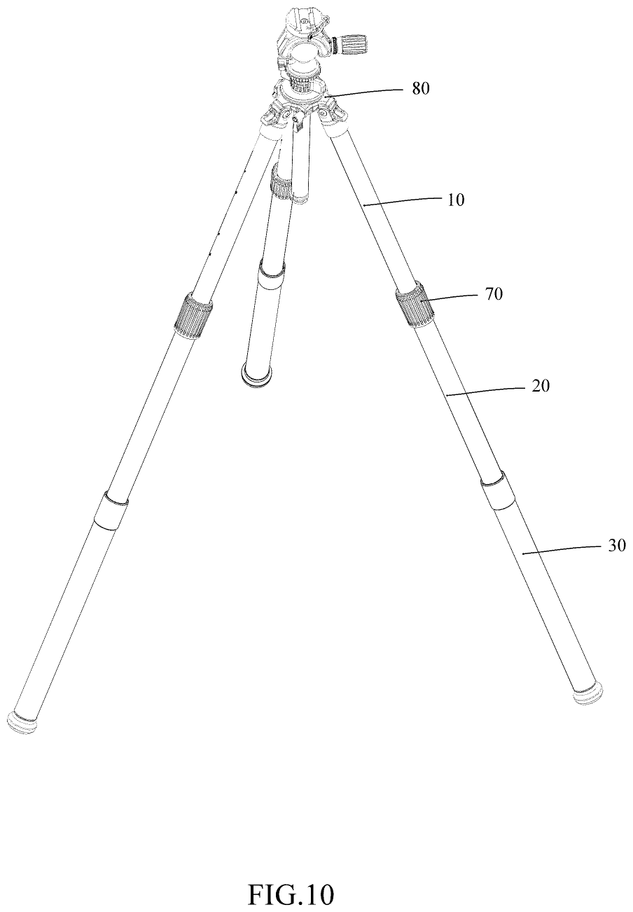

Referring to FIG. 10, the quick locking mechanism is applied in a tripod, wherein the first leg tube 10 is hinged to a pan-tilt head 80.

In the description of the present invention, it should be understood that terms such as “center,” “longitudinal,” “transverse,” “length,” “width,” “thickness,” “upper,” “lower,” “front,” “rear,” “left,” “right,” “vertical,” “horizontal,” “top,” “bottom,” “inner,” “outer,” “clockwise,” and “counterclockwise,” describing orientations or positional relationships, are based on the orientations or positional relationships illustrated in the drawings. These terms are employed merely for convenience in describing the present invention and for simplifying the description, and should not be construed as requiring that the referenced device or element must have a particular orientation, or be constructed or operated in a particular orientation. Likewise, the terms “first” and “second” are used merely for descriptive purposes and should not be construed as indicating or implying relative importance, nor as implying a particular numerical limitation with respect to the referenced technical features.

The foregoing description illustrates the fundamental principles, essential features, and advantages of the present invention. It will be understood by those skilled in the art that the present invention is not limited to the embodiments described above. The embodiments and description provided in the specification serve only to illustrate the principles of the invention. Various modifications and improvements may be made without departing from the spirit and scope of the present invention, all of which fall within the scope of protection defined by the appended claims and their equivalents.

What is claimed is:

1. A quick locking mechanism for tripod leg tubes, comprising:
a first leg tube, a second leg tube, and a third leg tube sequentially fitted together;
a first locking mechanism disposed between the first leg tube and the second leg tube;
a second locking mechanism disposed between the second leg tube and the third leg tube; and
a synchronization shaft jointly received within the first leg tube, the second leg tube, and the third leg tube, the first locking mechanism and the second locking mechanism both being coupled to the synchronization shaft;
wherein the second leg tube is rotatably arranged relative to the first leg tube and the third leg tube, such that when the second leg tube is rotated in a first direction, the first locking mechanism and the second locking mechanism are synchronously actuated to perform a locking action, and when the second leg tube is rotated in a second direction, the first locking mechanism and the second locking mechanism are synchronously actuated to perform an unlocking action.

2. The quick locking mechanism for tripod leg tubes according to claim 1, wherein the first locking mechanism comprises:
a first locking sleeve fixed to a lower end of the first leg tube;
a sliding sleeve sleeved around the synchronization shaft;
a first restraining ring formed on the first locking sleeve and engaging an outer wall surface of the sliding sleeve;
a second restraining ring disposed at an upper end of the sliding sleeve;
a first spring sleeved around the sliding sleeve between the first restraining ring and the second restraining ring;
a rotatable linkage member rotatably mounted on the sliding sleeve below the first restraining ring; and
a plurality of first clamping jaws disposed on the rotatable linkage member, each first clamping jaw having an inner wall surface formed as a first tapered surface, the first locking sleeve having an outer wall surface formed as a second tapered surface, the first tapered surface being in fitted engagement with the second tapered surface, an outer wall surface of each first clamping jaw engaging an inner wall of the second leg tube;
wherein the rotatable linkage member is arranged to rotate synchronously with the second leg tube and to move upward and downward relative to the second leg tube; and
wherein an upper surface of the rotatable linkage member is formed with a plurality of first guide cam blocks arranged in a circumferential array, and a lower surface of the first locking sleeve is formed with a plurality of second guide cam blocks, each first guide cam block being in fitted engagement with a corresponding second guide cam block.

3. The quick locking mechanism for tripod leg tubes according to claim 2, wherein a restraint base is fixed to the synchronization shaft below the rotatable linkage member, the restraint base being formed with a guiding track channel, and the rotatable linkage member being provided with a guiding block movably inserted into the guiding track channel.

4. The quick locking mechanism for tripod leg tubes according to claim 2, wherein an outer wall surface of each first clamping jaw is provided with a first friction lining configured to engage an inner wall surface of the second leg tube.

5. The quick locking mechanism for tripod leg tubes according to claim 3, wherein an outer wall surface of each first clamping jaw is provided with a first friction lining configured to engage an inner wall surface of the second leg tube.

6. The quick locking mechanism for tripod leg tubes according to claim 2, wherein the sliding sleeve is provided with a longitudinal guidance slot, and the first restraining ring is provided with an alignment pin movably inserted into the longitudinal guidance slot.

7. The quick locking mechanism for tripod leg tubes according to claim 3, wherein the sliding sleeve is provided with a longitudinal guidance slot, and the first restraining ring is provided with an alignment pin movably inserted into the longitudinal guidance slot.

8. The quick locking mechanism for tripod leg tubes according to claim 1, wherein the second locking mechanism comprises:
a second locking sleeve fixed to a lower end of the second leg tube;
a stationary sleeve fixed to a lower end of the synchronization shaft;
a third restraining ring formed on the second locking sleeve and engaging an outer wall surface of the stationary sleeve;
a fourth restraining ring disposed at an upper end of the stationary sleeve;
a second spring sleeved around the stationary sleeve between the third restraining ring and the fourth restraining ring;
a stationary coupling member fixed to the stationary sleeve; and
a plurality of second clamping jaws disposed on the stationary coupling member, each second clamping jaw having an inner wall surface formed as a third tapered surface, the second locking sleeve having an outer wall surface formed as a fourth tapered surface, the third tapered surface being in fitted engagement with the fourth tapered surface, an outer wall surface of each second clamping jaw engaging an inner wall surface of the third leg tube;
wherein an upper surface of the stationary coupling member is formed with a plurality of third guide cam blocks arranged in a circumferential array, and a lower surface of the second locking sleeve is provided with a plurality of fourth guide cam blocks, each third guide cam block being in fitted engagement with a corresponding fourth guide cam block; and
wherein the stationary coupling member is slidably arranged within the third leg tube.

9. The quick locking mechanism for tripod leg tubes according to claim 8, wherein an outer wall surface of each second clamping jaw is provided with a second friction lining configured to engage an inner wall surface of the third leg tube.

10. The quick locking mechanism for tripod leg tubes according to claim 1, wherein the second leg tube is fixedly provided with a rotational grip sleeve.
